(19) United States
(12) Patent Application Publication
(10) Pub. No.: US 2014/0344190 A1
(43) Pub. Date: Nov. 20, 2014

(54) Method for Creating Coordinated Non-Matching Products and the Corresponding Products

(71) Applicant: DELTA GALIL USA INC., SECAUCUS, NJ (US)

(72) Inventors: Jonah Staw, San Francisco, CA (US); Arielle Eckstut, San Rafael, CA (US); Leslie Jonath, San Francisco, CA (US)

(73) Assignee: DELTA GALIL USA INC., SECAUCUS, NJ (US)

(21) Appl. No.: 14/250,462

(22) Filed: Apr. 11, 2014

Related U.S. Application Data
(62) Division of application No. 12/691,590, filed on Jan. 21, 2010, now abandoned.
Application No. 12/691,590 is a division of application No. 10/827,392, filed on Apr. 19, 2004, now abandoned.

(51) Int. Cl. G06Q 90/00

(52) U.S. Cl. CPC G06Q 90/00
USPC 705/500

(57) ABSTRACT

This invention is a unique method to manufacture, package, market, distribute and sell coordinated non-matching items which have traditionally been matched. This invention includes the creation and use of a system for coordinating the non-matching items. It further includes the packaging of the coordinated non-matching products in both traditional and non-traditional quantities.

### RELATED APPLICATION

This application is a division of application Ser. No. 10/827,392 filed Apr. 19, 2004, the entire disclosure of which is incorporated herein by reference.

### BACKGROUND OF THE INVENTION

1. Field of Invention

The present invention relates to a unique system and method for manufacturing, packaging, marketing, distributing and selling coordinated but non-matching items which have traditionally been essentially matching. For purpose of this invention matching should be construed to mean the grouping of items in like colors and patterns or in predefined number of items per distributed package, such as socks that are sold in pairs to accommodate the 2 feet of the human body.

2. Description of Prior Art

Many items are produced and sold in essentially matching pairs. Two feet, two eyes, two ears, two halves of a whole—the body is a bilateral object which in the history of fashion and retail has been treated in pairs. Shoes have been sold in pairs. Socks have been sold in pairs. Gloves have been sold in pairs. Earrings have been sold in pairs. Historically, fashion basics have been about symmetry and balance; fashion designers and retail stores have served this idea by selling bilateral items in matching identical pairs. If the pair was broken or one was lost, the total was then invalid. This has also applied to items not sold as pairs or even related to a body such as furniture in a room, appliances in a kitchen or bathroom and the parts in a game.

There are segments of the population who choose not to match. The current merchandising model (for example in the sock market) does not accommodate this cross section of society.

Customer choice has been limited to buying items matched in traditional ways of same colors, same designs, same shapes, etc. Those segments of the population who choose not to match these items are forced to purchase multiple item packages in order to accommodate their disposition, or are required to customize the items accordingly. This also applied to singular items with multiple parts; for example, legs of a pair of pants; sleeves of a shirt/coat/sweater; ear muffs; chairs for a dining set; and walls in a room. There has not been a system designed for mass production and mass marketing which goal is the production and distribution of non-matching items.

### SUMMARY OF THE INVENTION

The intention of this invention is to manufacture, market, distribute and sell coordinated but non-matching items instead of the traditional matched pairs, groups, sets or parts of an item. For purposes of this invention, coordinated but non-matching items refers to items which are coordinated in accordance with a defined system, but not matched in a conventional manner. Examples of items sold under this invention would include items typically sold as pairs (e.g., socks, gloves, earrings, etc.); items sold as one unit with different parts to it (e.g., legs of pants, sleeves of shirt; front/back or top/bottom of dress; sides of a car, a sleeping bag, etc.); as well as typically grouped items (e.g. cushions on a couch, chairs and tables, chairs in a dining set, walls in a room, etc.). In addition, this invention packages and distributes these coordinated but non-matching items in non-traditional quantities (e.g., 3, 5, 7 socks).

### BRIEF DESCRIPTION OF DRAWINGS

### Tables:

Table 1—lists example items traditionally sold in pairs.
Table 2—lists example items with distinguishable sections.
Table 3—lists example items with multiple parts or pieces.
Table 4—lists example items with inner and outer surfaces.
Table 5—lists examples of grouped items.
Table 6—lists example characteristics to coordinate non-matching items.

### FIGURES

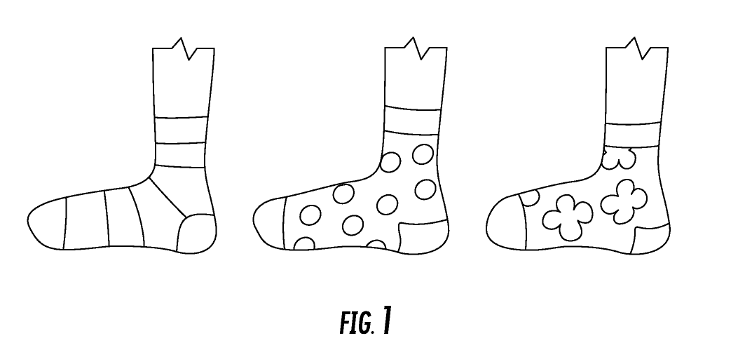

FIG. 1 illustrates example grouping for 3 coordinated but non-matching socks.

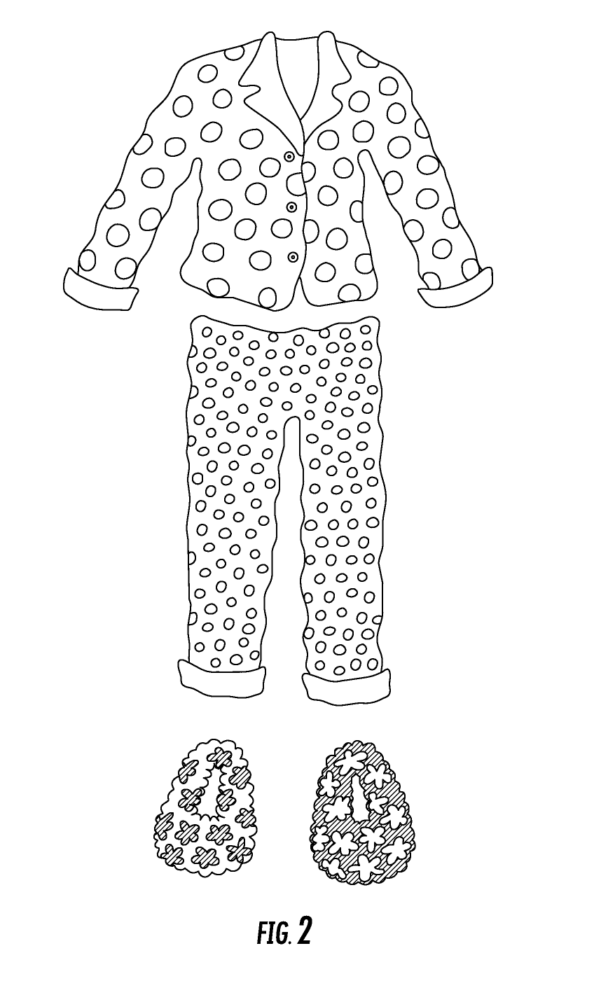

FIG. 2 illustrates sample coordinated but non-matching pajamas and slippers.

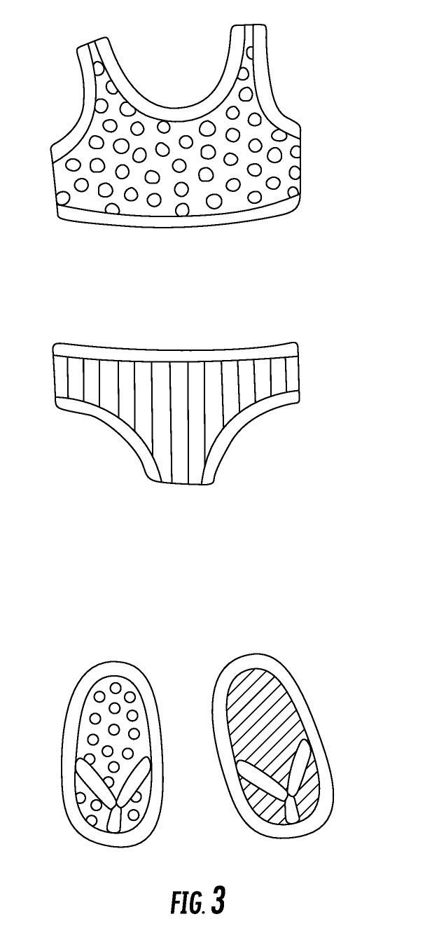

FIG. 3 illustrates sample coordinated but non-matching 2-piece bathing suit and sandals.

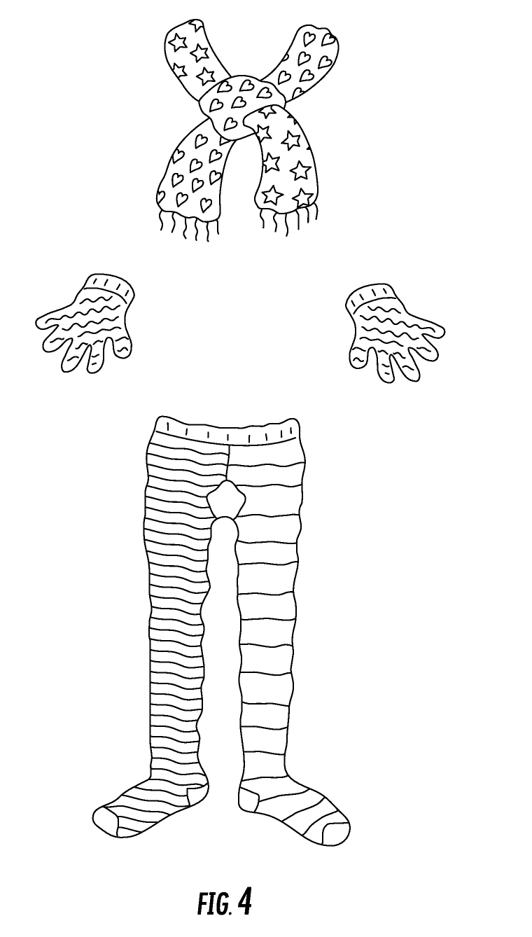

FIG. 4 illustrates sample coordinated but non-matching tights, gloves and scarf.

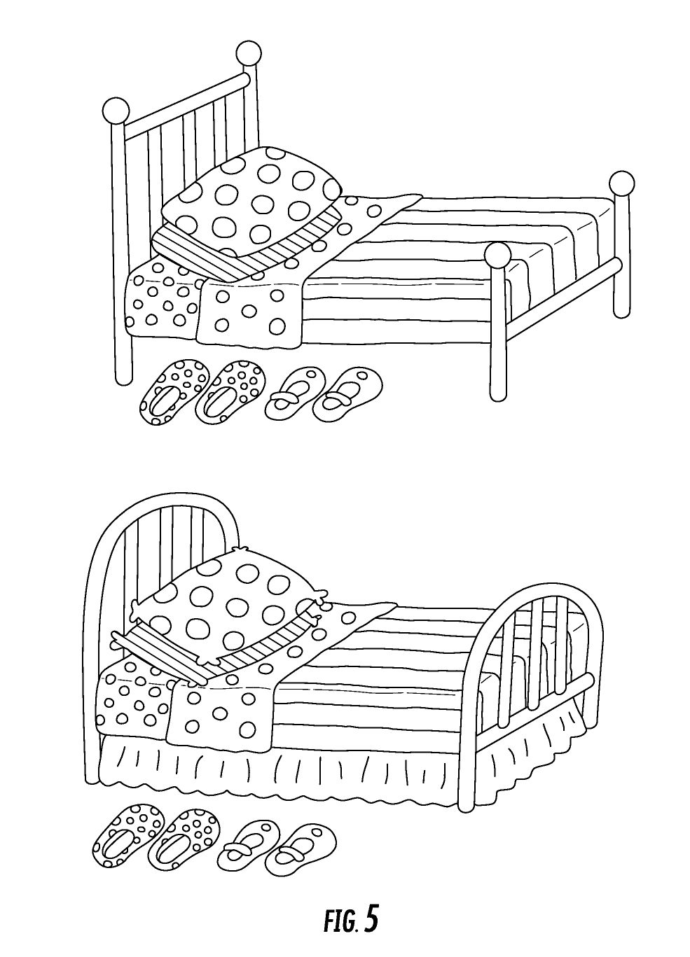

FIG. 5 illustrates sample coordinated but non-matching bedding and slippers.

### DETAILED DESCRIPTION OF PREFERRED EMBODIMENT

The present invention is a method for manufacturing, grouping, marketing, distributing and selling coordinated but non-matching items or products. This invention is applicable to 5 main categories of items. Examples of each category are listed on Tables 1-5. Although not matched, this invention includes means for coordinating the non-matching items.

The first category of items to be coordinated but non-matching in accordance with this invention are items traditionally sold in pairs. Table 1 is a list of typical items in this category. It is envisioned that items in this category will be sold in single packages of both traditional (e.g. 2) and non-traditional (e.g. 3, 5, 7) quantities. The items in a package will be coordinated but non-matching. Each pack of coordinated but non-matching items will coordinate within the pack and beyond by complying with a system for creating coordinated non-matching products. The Example System for Creating Coordinated Non-Matching Items defines a coordination means directed towards target consumer group, such as children. FIG. 1 illustrates an example of coordinated non-matched socks.

The second category of items to be coordinated but non-matching in accordance with the invention are items with distinguishable parts or pieces. Table 2 is a list of typical items in this category. It is envisioned that each item in this category could be coordinated but non-matching in multiple ways. For example, a shirt could be coordinated but non-matching from front to back, from right sleeve to left sleeve, from top to bottom. Eyeglasses could be coordinated but non-matching from left eye frame to right eye frame, or from left arm of frame to right arm of frame. The lenses themselves could even be coordinated but non-matching in tint of lenses or shape. As with all categories identified per this invention, the items are non-matching but coordinated in accordance with a defined system. The main features of the Example System for creating Coordinated but Non-Matching Items could be applied in this category also.

The third category of items to be coordinated but non-matching in accordance with this invention are items with multiple parts or pieces. Table 3 is a list of typical items in this category. As the examples listed in Table 3 show, this invention can be applied to essentially any product sold. Again, the items in this category would be coordinated in accordance with a defined system for coordinating but non-matching. Although the colors, shapes, patterns and other coordination means may change, the same principles included in the Example System for Creating Coordinated but Non-Matching Items would apply. FIGS. 2 and 3 illustrate examples of coordinated non-matched pajamas and bathing suits. This invention also envisions packaging the coordinated non-matching products in this category in non-traditional quantities (e.g. 3 sheets, 3 pillow cases, etc.)

The fourth category of items to be coordinated but non-matching in accordance with this invention are items with inner and outer surfaces. Table 4 is a list of typical items in this category. The inside and outside of items in this category would be non-matching but coordinated in accordance with a defined system. Again the basic principles included in the Example System for Coordinated Non-Matching Items presents possible means to coordinate the non-matching.

The fifth category of items to be coordinated but non-matching in accordance with the invention are items within a group. Table 5 in a list of typical items in this category. This invention can be applied to essentially any product within any grouping. Based on the grouping involved and the end uses of the grouping, the colors, shapes, patterns, etc. defined in the Example System for Creating Coordinated Non-Matching Items may be changed, but the basic principles of defined coordination would be applied. FIGS. 2, 3, 4, and 5 illustrate example coordinated but non-matched items within groups. As with products in categories 1 and 3, this invention envisions purchasing products in both traditional and non-traditional quantities (e.g. 3 drapes, etc.) for items in Category 5.

Example System for Creating Coordinated but Non-Matching Items

### 1. 1. Color

Color is one of the most important design features utilized by this invention. From afar, color is intended to be a primary eye-catcher of this invention. The color philosophy is one that is intended to stand out from the pack and draw consumers to the products distributed using the color scheme under this invention. One possible color philosophy would borrow from the greatest color specialist in the world: Nature. Early humans learned about beauty from nature and, to this day, we are programmed to be drawn to her exquisite creations first and foremost. So while the colors look modern, playful and full of whimsy, this Example System for Coordinated Non-Matching actually employing age-old aesthetic principles that have been scientifically proven as enticing to our brains. Following are some example color schemes that could be used to coordinate non-matching products under this invention, such as the coordination of socks.

1.1 Every Girl's Favorite Colors

Within the brand, there are three main colors that are nearly every girl's favorite: pink, purple and blue. This invention takes these three colors and chosen a dark and light version of each making a total of 6 main colors to choose from. There are also 3 supporting colors: orange, green and yellow. And three neutrals: white, gray and black.

### 2. 1.2 Warm & Friendly Colors

All the colors chosen are very warm in tone—the pinks have a lot of orange in them and the blues and purples a lot of red. The yellow is tinged with orange, the orange itself is sunny and vibrant and the green grassy. Even the chosen gray has a warm tone. This warmth is not just technical, but also emotional. By choosing these warm colors, the products of this invention scream friendliness and warmth. In addition, the chroma of each color is intense. This intensity also adds to the friendliness of the brand. All in all, when mixed and matched, these colors make a big statement that is thoroughly inviting to parents and kids.

1.3 Color Schemes

Every sock is made up of two colors and a neutral. The choice of neutral is determined by the pairing of the two dominant colors. The two dominant colors can be broken down into three different kinds of combinations:

Monochromatic (in our case, light and dark)

Analogous (colors that sit next to each other on the color wheel)

Complementary (colors that stand opposite each other on the color wheel)

All monochromatic schemes are accompanied by white; all analogous with gray; all complementary with black. Here are examples of possible color schemes for three of the main colors.

DARK BLUE SCHEMES

Monochromatic: dark blue, light blue and white

Analogous: dark blue, dark purple and gray or dark blue, green and gray

Complementary: dark blue, orange and black

LIGHT PINK:

Monochromatic: light pink, dark pink and white

Analogous: light pink, orange and gray or light pink, light purple and gray

Complementary: light pink, green and black

DARK PURPLE:

Monochromatic: dark purple, light purple and white

Analogous: dark purple, dark blue and gray or dark purple, dark pink and gray

Complementary: dark purple, yellow and black

1.4 Color Values

When putting together schemes between the three main colors that have both light and dark values, keep darks with darks and lights with lights.

CORRECT: dark pink, dark purple and gray

CORRECT: light pink, light purple and gray

INCORRECT: dark pink, light purple and gray

### 3. 1.5 Supporting Colors

Never use two supporting colors (orange, yellow, green) in the same sock. Supporting colors are just that: support for the main colors and they always need to be used in combination with one of the six main colors.

CORRECT: light pink, orange and gray

CORRECT: dark purple, yellow and black

INCORRECT: orange, yellow and gray

1.6 Complementary Schemes

With complementary schemes, always use black as the background color of the sock. Then choose a color for the shapes within the pattern based on which color creates the greatest contrast possible.

CORRECT: sock with black body, light pink ducks and green top, heel and toe.

CORRECT: sock with black body, orange ducks and dark blue top, heel and toe.

INCORRECT: sock with dark blue body, black ducks and orange top, heel and toe.

1.7 Color Mapping

Kids and parents will be relying on color to help them mix and match socks. In order to make them feel comfortable mixing and matching, it is important to keep consistency from sock to sock especially when it comes to the placement of color. For example, if working with one sock with large hearts and another with mini hearts, the colors are kept in the same areas of the socks, i.e. color #1 for the background, color #2 for the hearts, and your neutral for toe, heel and top.

CORRECT:
Sock with dark pink background, light pink large hearts and white top, heel, toe.
Sock with dark pink background, light pink mini hearts and white top, heel, toe.

INCORRECT:
Sock with dark pink background, light pink large hearts and white top, heel, toe.
Sock with white background, light pink mini hearts and dark pink top, heel, toe.

CORRECT:
Sock with dark blue and light blue thick stripes with white top, heel, toe.
Sock with dark blue and light blue waves with white top, heel, toe.

Because kids and parents will want as much choice as possible and because socks sold under this invention will more than likely be sold in “pairs” of three or groups of 6-7, it is important to keep consistent color mapping across patterns as well. This kind of consistency can happen in a variety of ways. It can be accomplished by using the same colors and mapping these consistently across patterns; by using different colors within the same scheme (monochromatic, analogous, complimentary) and mapping these consistently; or by a combination of the two.

CORRECT:
Sock with a gray background, light blue stars and green top, toe and heel.
Sock with a gray background, light blue mini stars and green top, toe and heel.
Sock with a gray background, light blue polka dots and green top, toe and heel.
Sock with a gray background, light blue mini polka dots and green top, toe and heel
Sock with a gray background, light blue hearts and green top, toe and heel
Sock with a gray background, light blue mini hearts and green top, toe and heel.

CORRECT:
Sock with dark purple and light purple large stripes and white top, toe and heel.
Sock with dark blue and light large stripes and white top, toe and heel.
Sock with dark pink and light pink large stripes and white top, toe and heel.

CORRECT:
Sock with dark purple and light purple large stripes and white top, toe and heel.
Sock with dark purple and light purple large swirls and white top, toe and heel.
Sock with dark blue and light blue large stripes and white top, toe and heel.
Sock with dark blue and light blue large swirls and white top, toe and heel.
Sock with dark pink and light pink large stripes and white top, toe and heel.
Sock with dark pink and light pink large swirls and white top, toe and heel.

### 2. Pattern

Just as important as colors are patterns. Once again, this invention uses patterns that employ age-old aesthetic principles and that are innately pleasing and easily recognizable. These patterns can be made of classic shapes, objects or shapes of objects, whose simple graphic configurations will never go out of style and yet will always feel fresh and playful.

Hearts

Stars

Polka Dots

Ducks

Stripes

Waves

2.1 Minis

If there's one thing you can depend on when it comes to girls' changing ideas of fashion, it's all things mini. Girls love mini version of the world around them, so this Example System For Coordinated Non-Matching includes a mini version for every pattern or pattern and/or object shape; mini hearts, mini stars, mini polka dots, mini ducks, mini stripes, mini waves. These are not only sweet and fun, but they make for great mixing and matching.

2.2 Shape Size

Except for our stripes and waves, all pattern shapes and/or object shapes have the same width and length within the large or mini size category. In other words, you could take one of our large hearts, large ducks, large stars or large polka dots and put each of them into the exact same sized box. By making all the shapes identical in size, we've made it much easier for parents and kids to mix and match.

Our stripes and waves are exactly the same width each other and as our pattern shapes. This makes it easy to mix and match between stripes and waves, and for the more adventurous parent or kid, it makes it easy to mix and match between stripes, waves and all of our pattern shapes.

CORRECT:

Large stars and Large Hearts

INCORRECT:

Small large Stars and Large Hearts

CORRECT: Mini heart of ¼″ width with mini stripe of ¼″ width

2.3 Balance

One of the most important features of our patterns is their sense of balance. With our stripes and waves, this balance is achieved by making each band the same size. With our pattern shapes, this balance is achieved by making the spaces between each shape the same size as the shape itself.

CORRECT:

Large stripe and mini stripe: stripes within each exactly the same size.

INCORRECT:

Mini stripe where every other stripe is larger than ones in between.

CORRECT:

Space between mini hearts identical to width and length of heart:

INCORRECT:

Mini hearts too close together.

2.4 Proportion

The proportion of large to mini hearts is also essential to creating a sense of balance. That's why all mini patterns are ⅓^{rd} the size of all large patterns whether they are hearts or stripes.

CORRECT:

Large stripes and mini stripes

CORRECT:

Large stars and mini stars

INCORRECT:

Smaller version of large stars and mini stars

This invention also includes almost numberless coordinated patterns based on seasons, function, activities, culture, etc. Example seasonal patterns may include such objects or shapes as:

Winter: Snowflakes

Spring: Bunnies (for Easter)

Summer: Flowers

Fall: Leaves

The same principles and techniques applied in the Example System for Creating Coordinated Non-Matching Items also apply across all categories of products. Each product will have a defined palette, color schemes, patterns, sizes etc. This invention envisions products in all the identified categories (FIGS. 1-5). Table 6 lists sample characteristics for achieving coordination for a product within each of the 5 categories defined by this invention.

This invention also envisions coordinated non-matching across categories. In addition, an appropriate system like the Example System for Creating Coordinated Non-Matching Items which targets girls would be created based on the age, sex, culture, function, organization etc. of the intended users. For example, a system for coordinated non-matching could be created based on the theme in a particular sports league.

The variety of applications and uses for this invention are almost limitless. It is even envisioned that the invention can apply to additional categories of coordinated non-matching patterns, shapes, objects, items, textures, etc. It is known that variations will be apparent to those skilled in the art. Thus, it is not intended that the present invention be limited to the specific terms disclosed, or to the specific colors, color schemes, shades of color, patterns, shapes, objects, holidays, activities, textures, seasonal theme characteristics, and sizes of objects and shapes disclosed herein. It is envisioned that changes such as mentioned concerning defining the appropriate system for creating coordinated but non-matching products, will be made without departing from the spirit and scope disclosed.

The coordination means or defined system of the present invention includes, among other things, coordinating non-matching patterns on selected items by selecting at least two different design features for use in developing the non-matching patterns which will be placed on various items. These design features may include any of the design features discussed above including color, color schemes, color values, color mapping, shades of color, different colors, seasonal theme characteristics, seasons, holidays, textures, objects, shapes of objects, activities, pattern shapes and size. If, for example, color is selected as one of the design features, color may include a plurality of colors, different shades of the same color, a single color, two different colors, selected dominant colors, neutral colors, and any combination thereof. Color schemes can be formulated from the selection of colors, or specific color schemes can likewise be selected as described above. Also, importantly, any number of design features may be selected for use in developing non-matching patterns on selected items. At a minimum, at least one of at least two different selected design features can be placed on at least one of the two identified items and the other selected design feature can be placed on the other identified item so as to form at least one pattern on each item. In coordinating the placement of the selected design features on at least two of the identified items, the various patterns formed on one selected item is non-matching or dissimilar to at least one pattern formed on each of the other selected items. Although each selected design feature may not be used on each individual selected item, the non-matching patterns developed on each of the selected items as, for example, illustrated in FIGS. 1-5 are coordinated in that some consistency in the non-matching patterns is carried throughout each individual selected item. This consistency may include using the same color for the object shapes associated with the selected item; it may include placement of color in the same location on the specific items such as keeping specific colors in the same area on each identified item; or it may include placing at least one of the selected design features on each item, or on each distinguishable section of such item, or on connected or unconnected pieces associated with the selected item, so as to form a commonality between such items. The key to the present system is that any number of non-matching or dissimilar patterns can be produced and developed by placing any number of selected design features in various arrangements on at least two selected items. Variegated color patterns, that is, developing different colored zones on a particular item can likewise be developed as part of the non-matching patterns when color and/or color schemes are selected as one of the design features. Variegated patterns in general, that is patterns developed by using a different arrangement of one or more of the selected design features, can likewise be developed using the present invention and such variegated patterns are again non-matching or dissimilar patterns as previously explained. The at least two selected design features may also include two different colors, two shades of the same color, two different textures of the same pattern, the same shape or object but of different size, and more. Other coordination methods and other arrangements of the selected design features to develop non-matching or dissimilar patterns are likewise recognized, anticipated and envisioned by the present invention.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

TABLE 1
Items traditionally sold in pairs.

Socks
Shoes
Leg Warmers
Slippers
Arm Warmers
Earrings
Boots
Gloves/Mittens
Ear Muffs
Shoelaces
Pillow Cases
Barrettes

TABLE 2
Items with distinguishable sections.

Eyeglasses
Shirts
Jackets/Coats/Vests
Pants
Tights
Underwear

TABLE 3
Items with multiple parts or pieces.

Pajama tops and bottoms
Pajama tops and bottoms and slippers
Bathing suit
Underwear
Shirt and pants
Bedding (top, bottom sheets, pillowcases, spreads, etc.)
Uniforms
Parts of Bike (for example, handlebars, seats, and fenders)
Parts of Watch (case, band, watch face, hands)
Drawers in Chest
Cushions and chair or couch
Blade and Shaft of Hockey Stick
Parts of Phone
Beads/Bands on Jewelry
Flatware
Luggage Sets
Towels
Bowls
Containers
Glassware
Pen sets
Seat covers

TABLE 4
Items with inner and outer surfaces.

Shirts
Sweaters
Jackets
Hats
Scarves
Book Covers
Bags
Sleeping bag

TABLE 5
Grouped items.

Bathroom accessories (for example, toothbrush holder, cup, trash can,
soap dish, etc.)
Bathroom Appliances (for example, sinks, toilets, tubs, mirrors)
Kitchen Accessories (for example, mixers, can openers, toasters, hot
plates)
Kitchen Appliances (for example stoves, microwaves, dishwashers,
refrigerators)
Furniture in a room
Games
Walls in a room
Chairs and a table
Rugs
Floor coverings
Curtains/Drapes
Seats in a vehicle
Clothing/uniforms for members of a team or organization

TABLE 6
Sample Coordinating Characteristics for coordinated but non-matching items.

Color
Shapes
Theme characters/objects
Seasons
Holidays
Activity

1-39. (canceled)

40. An item traditionally sold as a plurality wherein each item is coordinated with a non-matching pattern, the plurality of items comprising:
at least two non-matching design features arranged on said plurality of items to form at least one of said at least two non-matching design features on each of said plurality of items, wherein said at least two non-matching design features comprise unlike yet complementary colors or patterns, wherein said complementary colors are colors which stand opposite each other on the color wheel, and wherein said complementary patterns comprise identical shapes of different sizes or different shapes of identical sizes;
said at least two non-matching design features being arranged on said plurality of items such that the at least one pattern formed on each item of said plurality of items is different from one another; and
at least one of said at least two non-matching design features being common to each item of said plurality.

41. The item according to claim 40 wherein the at least two design features are selected from the group consisting of color, color schemes, different colors, shades of the same color, seasonal theme characteristics, seasons, holidays, objects, activities, pattern shapes, textures, and size.

42. (canceled)

43. The item according to claim 40 wherein said item is a sock.

44. (canceled)

45. (canceled)

46. The item according to claim 40 wherein said item is a shoelace.

47. The item according to claim 40 wherein said item is a legwarmer.

48. (canceled)

49. (canceled)

50. An item sold in quantities of three wherein each item is coordinated with a non-matching pattern, comprising:
at least two different non-matching design features arranged on said group of three items to form at least one of said at least two non-matching design features of each of said three items, wherein said at least two non-matching design features comprise unlike yet complementary colors or patterns, wherein said complementary colors are colors which stand opposite each other on the color wheel, and wherein said complementary patterns comprise identical shapes of different sizes or different shapes of identical sizes;
said at least two non-matching design features being arranged on said group of three items such that the at least one design feature formed on each such item is different from one another; and
at least one of said at least two non-matching design features being common to each item.

51. The item according to claim 50 wherein the at least two design features are selected from the group consisting of color, color schemes, different colors, shades of the same color, seasonal theme characteristics, seasons, holidays, objects, activities, pattern shapes, textures, and size.

52. The item according to claim 51 wherein said item is a sock.

53-61. (canceled)

62. The item according to claim 51 wherein at least one of the two selected design features includes color, and wherein at least one of the patterns formed on said at least some of said items includes a variegated color pattern.

63. The item according to claim 51 wherein at least one of the two selected design features includes a color scheme, and wherein at least one of the patterns formed on said at least some of said items includes a monochromatic color scheme.

64. The item according to claim 51 wherein at least one of the two selected design features includes a color scheme, and wherein at least one of the patterns formed on said at least some of said items includes an analogous color scheme.

65. The item according to claim 51 wherein at least one of the two selected design features includes a color scheme, and wherein at least one of the patterns formed on said at least some of said items includes a complimentary color scheme.

66. The item according to claim 63 wherein the monochromatic color scheme is accompanied by the color white.

67. The item according to claim 64 wherein the analogous color scheme is accompanied by the color gray.

68. The item according to claim 65 wherein the complimentary color scheme is accompanied by the color black.

69. The item according to claim 51 wherein at least one of the at least two selected design features includes color, and wherein said at least some of said items include at least two dominant colors and a neutral color, said neutral color being determined by the pairing of said two dominant colors.

70. The item according to claim 51 wherein at least one of the at least two selected design features includes at least two selected colors, and wherein at least one of the at least two selected design features includes the shape of at least one object, one of the selected colors being used for the background on said at least some of said items, and the other selected color being used for the shape of the object selected.

71. The item according to claim 51 wherein at least one of the at least two selected design features includes color, and wherein a plurality of colors are selected for use on said at least some of said items, said plurality of colors being consistently mapped across the non-matching patterns formed on said items.

72. The item according to claim 51 wherein said item is a legwarmer.

73. An item sold in quantities of three wherein each item is coordinated with a non-matching pattern, comprising:
at least two non-matching design features arranged on said group of three items to form at least one of said at least two non-matching design features pattern of each of said three items, wherein said at least two non-matching design features comprise unlike yet complementary colors or patterns, wherein said complementary colors are colors which stand opposite each other on the color wheel, and wherein said complementary patterns comprise identical shapes of different sizes or different shapes of identical sizes;
said at least two non-matching design features being arranged on said group of three items such that the at least one design feature formed on each such item is different from one another;
at least one of said at least two non-matching design features being common to each item; and
said group of three items comprising said at least two non-matching design features being packaged together for sale.
